(19) United States
(12) Patent Application Publication
(10) Pub. No.: US 2002/0172318 A1
(43) Pub. Date: Nov. 21, 2002

(54) Device for catalytic conversion of hydrogen

(75) Inventors: Peter Brockerhoff, Julich (DE); Wrner Von Lensa, Langerwehe (DE); Emst-Arndt Reinecke, Aachan (DE); Moritz Voswinkel, Aachen (DE)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: FORSCHUNGSZENTRUM JULICH GmbH, Julich (DE)

(21) Appl. No.: 10/147,007

(22) Filed: May 15, 2002

Related U.S. Application Data
(62) Division of application No. 09/600,239, filed on Jul. 13, 2000.
Application No. 09/600,239 is a 371 of international application No. PCT/EP99/00107, filed on Jan. 11, 1999.

(30) Foreign Application Priority Data
Jan. 17, 1998 (DE) 198 01 618.2

(51) Int. Cl. G21C 9/00

(52) U.S. Cl. 376/301

(57) ABSTRACT

A device for the catalytic conversion of hydrogen in a containment of a reactor containing a gas mixture. The device includes a recombiner which is disposed in the containment and has a plurality of catalytically active catalyst elements, a first cooling unit which is disposed upstream of the recombiner and cools the gas mixture and a second cooling unit disposed downstream from and behind the recombiner. The device effectively eliminates hydrogen resulting from an accident in the containment, without flashback. The device also suppresses heating of the atmosphere in the containment.

### CROSS-REFERENCE TO RELATED APPLICATIONS

This application is a divisional application of application Ser. No. 09/600,239 filed Jul. 13, 2000, which is a U.S. national phase application under 35 USC 371 of International Application PCT/EP99/00107 filed Jan. 11, 1999.

### BACKGROUND OF THE INVENTION

1. Field of the Invention

The invention relates to a device for the catalytic conversion of hydrogen, with which device hydrogen resulting from an accident is eliminated effectively and without flashback both in noninerted and in inerted spaces, such as the containment vessels of pressurized and boiling water reactors or in other hydrogen applications.

2. Background Information

In the case of the pressurized water reactor, the hydrogen can be eliminated directly inside the device, for example, by means of catalytic recombiners, in the presence of the atmospheric oxygen contained in the containment, whereas in the case of the boiling water reactor, the oxygen necessary for reaction is supplied from outside into the device

During serious accidents in water-cooled nuclear reactors, steam and hydrogen pass into the containment vessel. The maximum hydrogen flow can reach about 20,000m³ at NTP in both pressurized and boiling water reactors. In pressurized water reactors, the atmospheric oxygen present in the containment vessels leads to the danger of uncontrolled ignition followed by detonation with additional pressure-induced dynamic stresses and strains on the containment walls. In some containments of boiling water reactors, nitrogen is used for inerting. In addition, secondary inerting measures following the occurrence of an accident are under discussion in order to prevent an explosive reaction of the hydrogen with the atmospheric oxygen. Steam and hydrogen, however, always cause pressure and temperature rises in the accident atmosphere. In boiling water reactors the relative pressure rise is intensified by the fact that their containment volume is only about 20,000m³, compared with the 70,000m³ for pressurized water reactors. Pressure and temperature rises lead to increased stress and strain on the containment walls. Furthermore, in the case of leaks caused by the excess pressure, a risk exists of escape of radiotoxic substances.

In the case in particular of noninerted containments in pressurized water reactors, the hydrogen is additionally subjected to the catalytic conversion in order to prevent explosions. Nevertheless, the efficiency of the recombiners, through which the atmosphere flows by free convection, is limited by the fact among others that the ignition temperature must not be exceeded at the outlet or on the housing surfaces.

The effectiveness of recombiners can be severely impaired by stratification, or in other words formation of distinct layers, in the upper part of the containment. This can occur in particular when noncondensible gases and airborne substances (aerosols) adhere to the surfaces of the recombiner plates and interfere with their action.

Attempts have been made in the prior art to overcome the problem of adherence of noncondensible gaseous substances by means of inclined, finned cooling tubes and to allow the cooled noncondensible gases to flow off downward by virtue of their higher density. This method fails, however, in the case of light noncondensible gases such as hydrogen or mixtures of noncondensible gases with hydrogen, and also in the case of stratification. Condensation of the steam contained in the accident atmosphere leads to the desired objective of lowering pressure and temperature and thus to reducing the danger of leaks with subsequent release of radiotoxic substances. The partial pressure of condensible and noncondensible gases, however, is influenced only by the cooling and recombination effects. It therefore represents a long-lasting driving force for leakage of radiotoxic substances and should be lowered to around atmospheric pressure in the shortest possible time.

German Patent Application DE 42 21 693 Al, from which the present invention is derived, discloses a method and a device for thermal recombination of a gas or gas mixture, especially of hydrogen and oxygen, in the containment atmosphere of a nuclear reactor plant, wherein a reaction gas is first mixed in and then fed to a reaction chamber. To increase the effectiveness of recombination under such circumstances, the reaction gas is preheated before being mixed with the gas mixture and thus before entry into the reaction chamber. Recombination of the hydrogen then takes place in the reaction chamber. The gas mixture exiting the reaction chamber is then fed to a heat exchanger disposed in the flow zone upstream from the inlet to the reaction chamber, so that this heat exchanger is used on the one hand for heating the gas mixture entering the reaction chamber and on the other hand for cooling the gas exiting the reaction chamber.

From German Patent Application DE 28 52 019 A there is further known a method and a device for the catalytic recombination of hydrogen and oxygen, wherein the mixture of steam and gas exiting the recombiner is delivered to a steam cooler, whereby cooling of the gas mixture is achieved. On the one hand, an electrical heating element is proposed for heating the catalyst material. On the other hand, superheated steam is supplied to the gas mixture for further heating of the catalyst, especially during the starting phase.

Both known prior art devices for the catalytic conversion of hydrogen described in the foregoing are therefore provided with means for heating the catalyst material itself or for heating the inflowing gas mixture. Thereby the catalytic material is brought to the temperature necessary for recombination inside the recombiner, although the proportion of steam in the gas mixture is considerable, thus leading to inerting of the catalytically active surfaces in the recombiner. Because of the additional heating of the recombiner, moreover, there exists the problem that the ignition temperature could be exceeded, with the resulting danger of flashback of the gas mixture.

### SUMMARY OF THE INVENTION

The technical problems on which the invention is based are therefore to improve the action of the recombiner, to suppress heating of the containment atmosphere by the heat generated during recombination, to contribute on the whole to cooling of the accident atmosphere and to prevent overheating of the recombiner with the consequence of flashback.

The technical problems discussed in the foregoing are solved according to the invention by a device having the features described hereinbelow. According to the invention, it has been recognized that, in a device for the catalytic conversion of hydrogen, a recombiner must be combined with a cooling unit, which is disposed downstream from, behind and adjacent to the recombiner. Thereby the heat of reaction generated during the catalytic recombination is effectively reduced and removed from the accident atmosphere. The temperature in the accident atmosphere is not further increased by the catalytic recombination, thus ensuring that the ignition temperature cannot be exceeded at the outlet of the device for the catalytic conversion of the hydrogen. Furthermore, the efficiency of the device for the catalytic conversion of hydrogen is improved in that a cooling unit is disposed upstream, or in other words, before the point at which the stream of a gas mixture enters the recombiner. Thereby the inerting of the recombiner by steam is diminished and the starting of the recombiner is improved, since steam is condensed before it can flow into the recombiner.

Preferably a device for drying the gas flow by drop collection is disposed in the flow direction between the first cooling unit and the recombiner. In this device there are preferably disposed plates with multiple deflectors, which in known manner further separate the water drops together with the adhering aerosols which have been entrained into or have been formed in the cooler and further predry the gas mixture entering the recombiner, since steam has an inhibiting effect on the catalytic recombination process. By virtue of the geometry of the device for drying the gas flow, the cooled noncondensible gases not sucked in by the recombiner at low hydrogen concentration can flow away downward with little resistance, as can the collected water drops and aerosols.

In a preferred embodiment of the invention, the cooling unit disposed upstream from the recombiner comprises downwardly inclined cooling tubes, which are provided with fins at predetermined spacings. In this way the major proportion of the steam contained in the gas mixture condenses. The water then adhering to the cooling tubes of the cooling unit runs off downward because of the inclination of the cooling unit, so that adhering noncondensible gases and deposited aerosols are continuously washed off again by the condensate. Thus both impaired heat transfer as well as a harmful retroactive effect on the catalytic surfaces due to the adherence of noncondensible gases and aerosols is diminished or even completely prevented. In this way, therefore, drying of the hydrogen and of the further substances by means of the cooling unit takes place by condensation of part of the steam.

By an arrangement of the catalyst elements oriented parallel to the flow direction, it is further ensured that flow is hindered only slightly, and so the flow necessary for passage through the cooling unit disposed downstream is still maintained. In a further preferred manner, the cooling unit is therefore disposed substantially above the recombiner. In a further preferred manner the cooling unit is downwardly oriented in the flow direction of the gas mixture, so that the cooling effect assists in driving the initially hot gas mixture downward. Thus both updraft and downdraft forces are utilized to increase the throughput, on the whole by virtue of the substantially vertical orientation.

In a further preferred manner, the recombiner of the device for the catalytic conversion of hydrogen is disposed substantially parallel to the cooling unit and to the device for drying the flow. Thereby it is ensured that the cooled, purified and predried stream of gas mixture either can flow away without problems at a low hydrogen concentration, in which case therefore the device acts as a cooler, or is passed almost in its entirety through the recombiner. The flow of gas mixture is then, as described hereinabove, passed through a further cooling unit. By adopting recombiners described in the prior art, however, other geometric catalyst arrangements, for example, of a horizontal type in vertical housings, can also be combined with the proposed coolers and flow deflectors.

A further embodiment of the present invention, differing from the embodiment described hereinabove, has a structure with a housing in which the cooling unit, the device for drying the flow, the recombiner and the downstream cooling unit are disposed. The stream of gas mixture entering through an inlet is conveyed by means of several turbine and compressor stages through the flow channel in the housing. Thus the flow passes successively through the first cooling unit and the device for drying the flow, after which the gas mixture travels through the recombiner and the adjoining cooling unit. Upstream from the outlet of the housing, the stream of gas mixture is forced out of the housing with a last compressor stage, thus achieving additional intimate mixing of the atmosphere in the containment and additionally decreasing the stratification in the containment. In a preferred manner, an additional device for drying the flow is disposed downstream from the second cooling unit in this embodiment, so that further collection of water and aerosols is achieved.

If at all possible, the described safety devices used for the embodiments of the invention described hereinabove should satisfy the principle of passive safety. In other words, they should operate without an external energy supply and activation. This is achieved, for example, with the inclined arrangement of cooling tubes to assist the natural convection in the cooling tubes. In principle, however, arrangements at different angular orientations are feasible with a view to a compact design or to the available space conditions.

Furthermore, it is only when the hydrogen concentration in the device is sufficiently high that the oxygen needed for the catalytic elimination of the hydrogen in the case of the boiling water reactor is supplied from outside selectively and at a controlled rate, thus ensuring that no ignitable mixture can form in the containment as a result of excessive oxygen.

### BRIEF DESCRIPTION OF THE DRAWINGS

The invention will be explained in more detail hereinafter on the basis of practical examples with reference to the drawings.

FIG. 1 is an elevational view which shows a first practical example of a device for the catalytic conversion of hydrogen with an upstream cooling unit and a device for drying the flow, for use in a pressurized water reactor.

FIG. 2 is an elevational view which shows a second practical example of a device for the catalytic conversion of hydrogen, for use in a boiling water reactor.

FIG. 3 is an elevational view which shows a third practical example of a device for the catalytic conversion of hydrogen as a combination with a multistage turbine compressor for the purpose of increasing the throughput, for use in pressurized and boiling water reactors.

FIG. 4 is a schematic view which shows a practical example of a device for drying the gas stream, which device is used in the devices for the catalytic conversion of hydrogen illustrated in FIGS. 1 to 3.

### DETAILED DESCRIPTION OF THE INVENTION

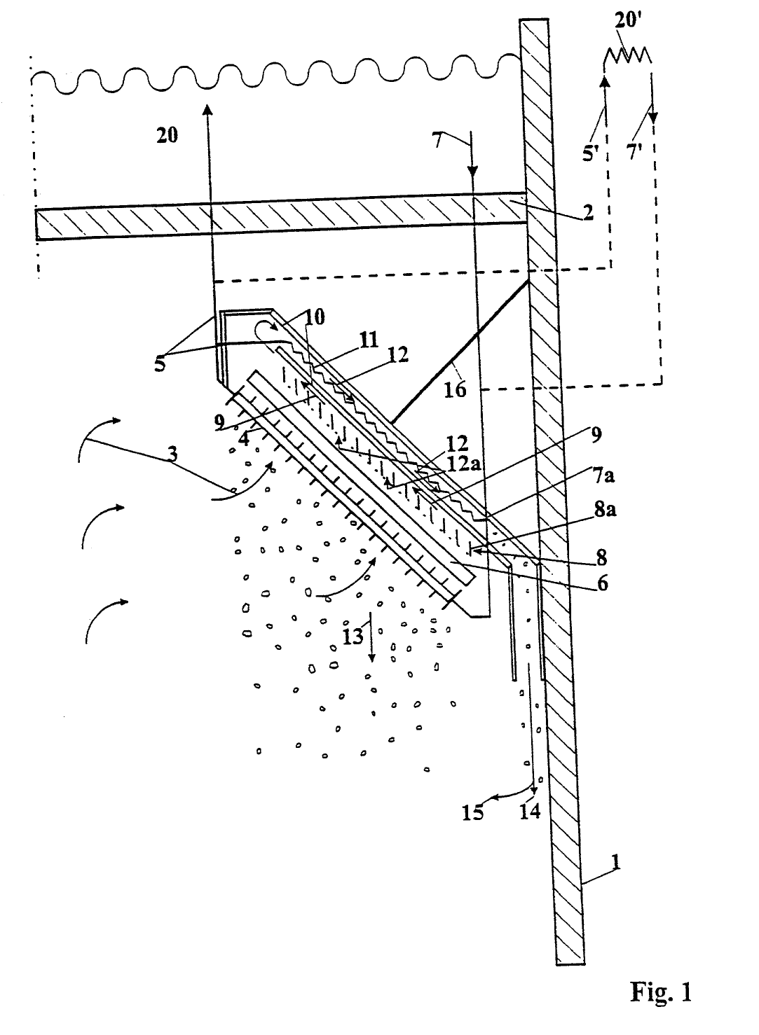

FIGS. 1, 2 and 3 each show a detail from a reactor plant. They illustrate schematically and by way of example the arrangement of different practical examples of the device for the catalytic conversion of hydrogen inside a containment of a pressurized water or boiling water reactor. This containment has walls 1 and 2, which represent the external boundaries. In the event of release of hydrogen, the gas mixture comprising steam, hydrogen and possibly air as well as aerosols flows in the direction of arrows 3 into the inlet of the device under the action of updraft.

As illustrated in FIG. 1, the first practical example of the inventive device for the catalytic conversion of hydrogen is provided with a recombiner 8 and a cooling unit 10. This recombiner 8 has a plurality of catalytically active plates 8a. Films can also be used instead of plates 8a. Furthermore, recombiner 8 is disposed directly in the containment that contains the gas mixture. Cooling unit 10 is disposed downstream behind recombiner 8 and is positioned adjacent thereto.

The supplied gas mixture, which contains hydrogen and oxygen, ignites at the surfaces of plates 8a, which are coated with catalytically active substances such as noble metals. Other recombiner systems with low flow resistance can also be used instead of plate-type recombiner 8 illustrated in FIG. 1. As a result of the exothermic reaction, the heated gas mixture and the combustion products of recombination travel upward into the gap located between recombiner 8 and the bottom wall of downstream cooling unit 10. To combat thermal stress and strain, the bottom wall of cooling unit 10 can be thermally insulated from recombiner 8, in order to reduce heat transfer through this wall.

The hot gas mixture, which is indicated by arrows 9, is deflected at the top and directed into cooling unit 10. This cooling unit 10 is expediently designed as a counterflow device, in which the flow directions of the stream of gas mixture on the one hand and of the stream of coolant in a coolant line 11 are opposite. Obviously the stream of gas mixture and the coolant stream can also be oriented in the same direction. The coolant, which in the present case is cooling water, is supplied via a line 7 to coolant line 11. The heated water is injected via line 5 into a water pool 20 which (as illustrated in FIG. 1) is located above the device for the catalytic conversion of hydrogen and outside the containment.

As the hot gas mixture flows through the cooling unit in the direction indicated by arrow 12, it gives up a large proportion of the heat of reaction which it contains, thus experiencing additional downdraft. Furthermore, part of the steam formed during the catalytic conversion of the hydrogen is condensed. The condensate, together with the cooled stream of gas mixture, is drawn off downward from cooling unit 10, as indicated by arrow 14. It can be used if necessary for further cooling purposes. The gaseous constituent of the mixture, nitrogen as well as small proportions of unconverted hydrogen and oxygen plus noncondensed steam, is indicated by arrow 15. Finally, the entire device is disposed in a laterally closed housing, which is fastened, for example, to a wall 1 of the containment by means of a schematically illustrated holder 16.

In addition to recombiner 8 and cooling unit 10, the practical example illustrated in FIG. 1 is provided with a cooling unit 4 for cooling the stream of gas mixture as well as with a device 6 for drying the flow.

Cooling unit 4 cools the hot ascending gas mixture, thus condensing the major proportion of the steam contained in the gas mixture.

FIG. 1 shows only one tube from a tubular bundle of cooling unit 4, which is also known as the building cooler. To improve the heat transfer coefficient, the tube surfaces are provided with fins such that deposited aerosols are continuously washed off again by the condensate or act as condensation nuclei and are precipitated.

As is further illustrated in FIG. 1, cooling unit 4 or the cooling tube is optimized with a view to utilizing updraft and downdraft forces for the gas mixture and for the internal flow through the cooling tubes. For this purpose the cooling tubes are inclined in order to force adhering condensate to run downward. Thus efficient cooling of the stream of gas mixture is ensured. Through cooling unit 4 there is passed a coolant, preferably cooling water, which is supplied via line 7 and removed via line 5. In this connection, the already mentioned water pool 20, which is disposed above the device for the catalytic conversion of hydrogen and outside the containment, is used as reservoir for the coolant.

The heat absorbed by the cooling water in cooling unit 4 is removed by virtue of thermal upwelling via line 5 to water pool 20 disposed above, thus ensuring that new cooling water is constantly drawn in again via line 7. If water pool 20 in the reactor were to fail, the thermal energy could also be removed to an external cooling-water tank or cooling unit 20′ mounted at a higher level, as indicated in FIG. 1.

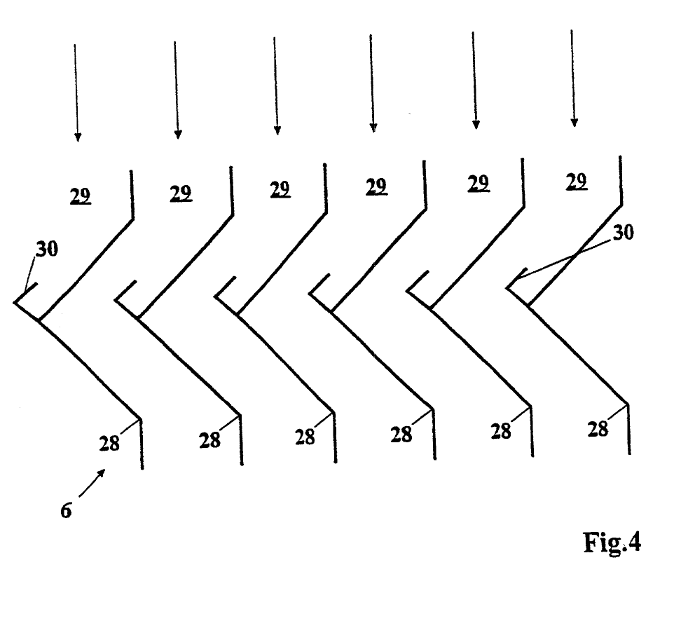

The mixture cooled in cooling unit 4, or in other words the building cooler, then flows through device 6 for drying the gas stream, which device is illustrated in FIG. 4. Device 6 acts to separate water drops and aerosols in known manner, for example, by decelerating part of the flow through an influence on the boundary layer or by collecting the remaining water drops by centrifugal forces in deflectors.

As illustrated in FIG. 4, device 6 for drying the gas stream is provided for this purpose with a plurality of walls 28 disposed parallel to one another, thus forming parallel flow channels 29. Because of the curved or angular profile of walls 28, the flow is forced to undergo multiple changes of direction, thus generating turbulence. There are also provided projections 30, at which the gas flow indicated by arrows banks up, so that the steam as well as any aerosols present are collected on walls 28. In this way the stream of gas mixture becomes dried and purified in device 6.

At a low hydrogen concentration, the device for the catalytic conversion of hydrogen functions substantially as a building cooler, whereas at higher hydrogen concentrations the gas mixture 12a cooled, purified and dried in this way then passes into recombiner 8. The illustrated embodiment of recombiner 8 with plates 8a disposed substantially parallel to one another is adapted in its orientation and arrangement of plates 8a to the inclination of cooling unit 4 as well as device 6 for drying the flow. Thereby the flowing-off process described hereinabove is not hindered, thus allowing the light gases to flow away upward almost without hindrance, in order to overcome the thermal siphon effect of the following gas-flow paths. The upstream cooling unit also acts to inhibit flashback, since the higher surface temperatures of the recombiner are shielded from the accident atmosphere.

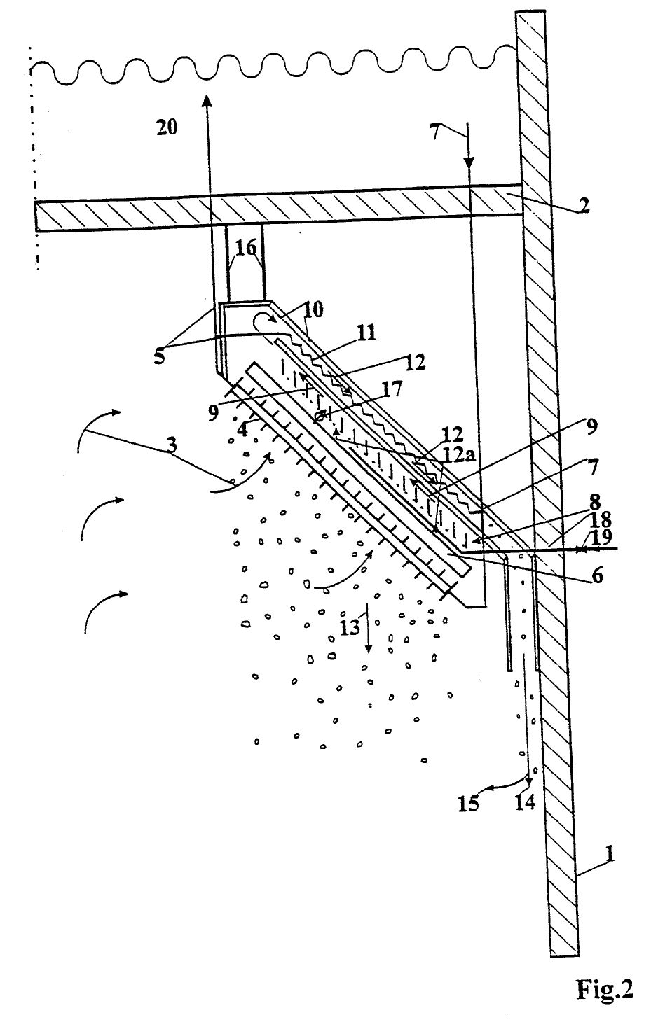

In FIG. 2, the device described hereinabove with reference to FIG. 1 is disposed in a containment or in the pressure suppression chamber of a boiling water reactor, whose atmosphere is inerted. Since no oxygen is present, it must be supplied selectively from outside whenever hydrogen in the containment is to be catalytically decomposed. Accurate monitoring of the hydrogen concentration is therefore necessary. Hydrogen sensor 17 can be disposed behind drop collector 6 as illustrated. The oxygen is injected selectively from outside as a finely dispersed stream via a line 18 in front of the recombiner unit. Pure oxygen should be supplied in order to avoid an additional pressure rise of the containment atmosphere. It can be metered in by means of a valve 19. This is dimensioned such that the oxygen is completely converted in the device in the event of hydrogen excess, ensuring that an ignitable mixture cannot form in the containment.

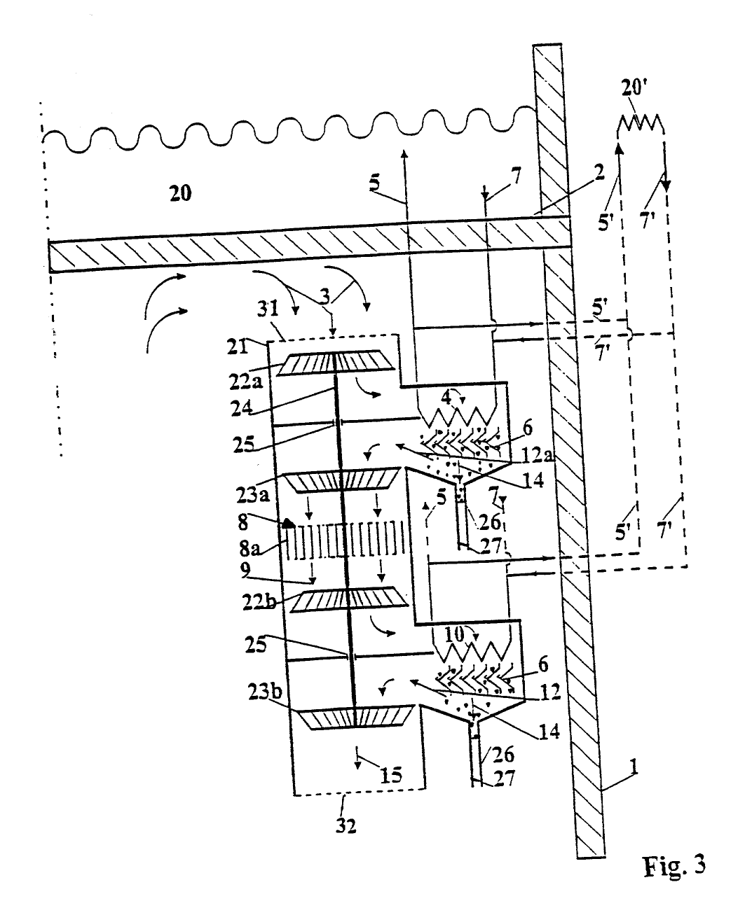

FIG. 3 illustrates an alternative embodiment of the device for the catalytic conversion of hydrogen. This embodiment is provided with a multi-stage turbine compressor unit 21, which is driven by the pressure decrease during condensation and by the pressure increase during recombination instead of by updraft and downdraft forces. This construction has the advantage of higher throughputs in the case of high steam and/or hydrogen concentrations, and so such a turbine compressor unit 21 is capable of effectively preventing stratification.

The mixture flowing in through inlet 31 and via a turbine stage 22a is supplied to a cooler, which creates the pressure decrease described hereinabove and, in cooperation with drop collector 6, also brings about drying and precipitation of aerosols. The noncondensible gases are supplied via a compressor stage 23a to a catalytic recombiner 8. In inerted containments, oxygen is also injected in finely dispersed form at this point, in a manner analogous to the combustion chamber of a turbine aero engine. The hot steam formed after recombination causes, depending on the permissible maximum temperature, a pressure increase. The exhaust gases are in turn delivered by the following turbine stage 22a to a cooler 10 for the purpose of lowering the temperature and pressure. The cold noncondensible gases are expelled via the final compressor stage 23b and outlet 32. This produces turbulence of the accident atmosphere without the danger of flashback. These turbine compressor stages 22a, 22b and compressor stages 23a, 23b are fastened on a common shaft 24.

The capacity per unit is greater in this construction than in the version described hereinabove. Autonomous starting is possible by virtue of easy-running bearings 25 of shaft 24 as well as utilization of updraft and downdraft forces in the starting phase. The starting process could also be assisted, however, by a drive motor, not illustrated here, coupled with shaft 24. Condensate and aerosols are delivered to downcomer 26, in which there is mounted a nonreturn valve 27 to vent return flow. From there they pass into the water pool, which is not shown in the drawings.

List of reference symbols

| | |
|---|---|
| 1 | Wall |
| 2 | Wall |
| 3 | Containment atmosphere |
| 4 | Cooling unit |
| 5 | Cooling water outlet |
| 5′ | Cooling water outlet |
| 6 | Drop collector |
| 7 | Cooling water inlet |
| 7′ | Cooling water inlet |
| 8 | Catalytic recombiner 8a Plate |
| 9 | Reaction gases (hot) |
| 10 | Cooling unit |
| 11 | Coolant line |
| 12 | Reaction gases (cooled) |
| 12a | Containment atmosphere (cooled and dried) |
| 13 | Condensate and aerosols |
| 14 | Condensate |
| 15 | Gaseous substances 16 Holder |
| 17 | Hydrogen sensor |
| 18 | Oxygen line |
| 19 | Control valve |
| 20 | Internal cooling-water pool |
| 20′ | External cooling-water pool |
| 21 | Turbine compressor unit |
| 22a | First turbine stage |
| 22b | Second turbine stage |
| 23a | First compressor stage |
| 23b | Second compressor stage |
| 24 | Shaft |
| 25 | Bearing |
| 26 | Downcomer pipe |
| 27 | Nonreturn valve |
| 28 | Walls |
| 29 | Flow channel |
| 30 | Projection |
| 31 | Inlet |
| 32 | Outlet |

What is claimed is:

1. A device for the catalytic conversion of hydrogen in a containment of a reactor containing a gas mixture, said gas mixture ascending under the action of an updraft, comprising:
a recombiner having an inlet and an outlet, said recombiner having a plurality of catalytically active catalyst elements,
a first cooling unit for cooling the gas mixture, said first cooling unit being disposed adjacent to the inlet of the recombiner, and
a second cooling unit being disposed adjacent to the outlet of the recombiner,
said first cooling unit, said recombiner, and said second cooling unit being disposed in the containment of the reactor and being fastened to at least one wall of the containment,
wherein the first cooling unit is disposed in direct contact with the ascending gas mixture, and
wherein the second cooling unit comprises an outlet for discharging the gas mixture into the containment.

2. The device according to claim 1, which further comprises a drying device for drying the gas mixture, said drying device being disposed between the first cooling unit and the recombiner.

3. The device according to claim 2, wherein the drying device comprises plates which are disposed parallel to one another and which have an angled or a bent configuration.

4. The device according to claim 1, wherein the second cooling unit is disposed substantially above the recombiner.

5. The device according to claim 1, which further comprises at least one bottom wall disposed between the second cooling unit and the recombiner such that the second cooling unit and the recombiner are thermally insulated from each other.

6. The device according to claim 1, wherein the second cooling unit is downwardly oriented in the direction of the flow of the gas mixture.

7. The device according to claim 2, wherein the first cooling unit and the drying device are disposed in a downwardly inclined orientation in the flow of the gas mixture.

8. The device according to claim 2, wherein the recombiner extends substantially parallel to the first cooling unit and to the drying device.

9. The device according to claim 1, which further comprises:
a housing in which there are disposed the first cooling unit, the drying device, the recombiner and the second cooling unit, said housing being provided with an inlet and an outlet;
a first turbine stage which is disposed upstream from the first cooling unit and the drying device;
a first compressor stage which is disposed between the drying device and the recombiner;
a second turbine stage which is disposed between the recombiner and the second cooling unit; and
a second compressor stage which is disposed downstream from the second cooling unit.

10. The device according to claim 9, which further comprises a second drying device which is disposed between the second cooling unit and the second compressor stage.

11. The device according to claim 1, which further comprises at least one sensor for measuring the hydrogen concentration, said sensor being disposed in front of the recombiner in the direction of flow of the gas mixture.

12. The device according to claim 1, which further comprises a device for supplying oxygen which introduces oxygen into the gas mixture in front of the inlet to the recombiner.

13. The device according to claim 3, which further comprises at least one bottom wall disposed between the second cooling unit and the recombiner such that the second cooling unit and the recombiner are thermally insulated from each other.

14. The device according to claim 13, which further comprises:
a housing having an inlet and an outlet, said housing containing the first cooling unit, the drying device, the recombiner and the second cooling unit;
a first turbine stage which is disposed upstream from the first cooling unit and the drying device;
a first compressor stage which is disposed between the drying device and the recombiner;
a second turbine stage which is disposed between the recombiner and the second cooling unit; and
a second compressor stage which is disposed downstream from the second cooling unit.

15. The device according to claim 14, which further comprises at least one sensor for measuring the hydrogen concentration, said sensor being disposed in front of the recombiner in the direction of flow of the gas mixture.

16. The device according to claim 15, which further comprises a device for supplying oxygen which introduces oxygen into the gas mixture in front of the inlet to the recombiner.

17. The device according to claim 16, wherein the catalytically active catalyst elements are coated with a noble metal.

18. The device according to claim 1, wherein the catalytically active catalyst elements comprise a noble metal.

19. A method for the catalytic conversion of hydrogen in a containment of a reactor containing a gas mixture, said gas mixture ascending under the action of an updraft, comprising:
(a) directing the ascending gas mixture directly into a first cooling unit for cooling the gas mixture before entering a recombiner, said recombiner having an inlet and an outlet, said recombiner having a plurality of catalytically active catalyst elements, said first cooling unit being disposed adjacent the inlet of the recombiner and being in direct contact with the gas mixture, whereby hydrogen is recombined with oxygen when in contact with the catalytically active catalyst elements of the recombiner, and
(b) directing the gas mixture into a second cooling unit for cooling the gas mixture before discharging the gas mixture into the containment, said second cooling unit being disposed adjacent to the outlet of the recombiner,
wherein said first cooling unit, said recombiner, and said second cooling unit are disposed in the containment of the reactor and are fastened to at least one wall of the containment.
